(19) United States
(12) Patent Application Publication
(10) Pub. No.: US 2017/0002591 A1
(43) Pub. Date: Jan. 5, 2017

(54) Door Locking System

(71) Applicant: Charles Taylor Brown, III, Hedgesville, WV (US)

(72) Inventor: Charles Taylor Brown, III, Hedgesville, WV (US)

(21) Appl. No.: 14/791,315

(22) Filed: Jul. 3, 2015

(51) Int. Cl. E05C 3/10; E05B 15/02

(52) U.S. Cl. CPC E05C 3/10; E05B 15/0205; E05B 2015/023

(57) ABSTRACT

A door locking system includes a first locking assembly and a second locking assembly. The first and second locking assemblies each have a locking actuator mounted on a door and a catch plate mounted on a door frame. Each of the locking actuators includes a lever and a locking plate, such that, in response to rotating the lever from an open position to a close position, the locking plate rotates from an unlocked position to a locked position, respectively, in which the locking plate is inserted into a groove of the corresponding catch plate when the locking plate is in its locked position.

### BACKGROUND OF THE INVENTION

1. Field of the Invention

The present general inventive concept relates to a door locking system. More particularly, the present general inventive concept relates to a door locking system configured for use primarily on a perimeter door of a house or building to enhance security.

2. Description of the Related Art

FIG. 1 illustrates an example of a conventional perimeter door locking system 10. A perimeter door 20, i.e., door used to enter a home or building, has a height H approximately 80″ and is typically equipped with a door knob lock 50 located approximately 35″ from a base edge 22 of the perimeter door 20 and substantially close to a first edge 23 of the perimeter door 20 and a deadbolt lock 60 located approximately 41″ from the base edge 22 of the perimeter door 20 and substantially close to the first edge 23 of the perimeter door. The perimeter door 20 is mounted to a door frame 40 using door hinges 30 along a second edge 24 of the perimeter door 20 that is opposite the first edge 23. The perimeter door 20 is typically mounted using three (3) door hinges 30.

Some perimeter doors may include a lock-and-chain lock 70 or a sliding deadbolt lock 80 typically arranged approximately 55″ from the base edge 22, i.e., 25″ from a top edge 21 of the perimeter door 20, and substantially close to the first edge 23 of the perimeter door 20.

However, the conventional door locking system 10 provides a minimal amount of security in that it can easily be defeated through the use of a lock-pick and a tension wrench or by applying force to the perimeter door 20 using a battering ram or a person's shoulder. That is, the conventional door locking system 10 provides a single point of failure 444 (hereinafter SPOF) in that each of the above described locks can be circumvented by either using a lock-pick and a tension wrench or by applying force to the SPOF 444, as illustrated in FIG. 1.

FIG. 2 illustrates an enhanced view of an example of a door knob lock 50 of FIG. 1. FIG. 2 provides the barest of components of a door knob lock 50 in order to briefly convey the nature of the device. The door knob lock 50 includes a rotatable door knob 81 mounted on the perimeter door 20, a plunger 88 configured to move in response to the rotation of the door knob 81, and a metal striker plate 84 mounted to the door frame 40. The metal striker plate 84 is typically secured to the door frame 40 using two (2) 0.5″ manufacturer-provided screws 85. After being inserted into the metal striker plate 84, the plunger 88 may be locked/unlocked from an extended state based on a position of a locking latch 82 located on the door knob 81.

FIG. 3 illustrates an enhanced view of an example of a deadbolt lock 60 of FIG. 1. FIG. 3 provides the barest of components of the deadbolt lock 60 in order to briefly convey the nature of the device. The deadbolt look 60 includes a mounting plate 181 mounted to the perimeter door 20, a deadbolt 188 configured to move in response to the rotation of a locking latch 180, and a metal striker plate 184 mounted to the door frame 40. The striker plate 184 is typically attached to the door frame 40 using two (2) 0.5″ manufacturer-provided screws 185. After being inserted into the metal striker plate 184, the deadbolt 188 may be locked/unlocked from an extended state based on a position of the locking latch 180.

FIG. 4 illustrates an enhanced view of an example of a lock-and-chain lock 70 of FIG. 1. FIG. 4 provides the barest of components of the lock-and-chain lock 70 in order to briefly convey the nature of the device. The lock-and-chain lock 70 includes a first metal plate 95 mounted to the inner surface 26 of the perimeter door 20 (i.e., the surface of the door that faces inside the home or building), a second metal plate 96 mounted to the inner surface 47 of the door frame 40 (i.e., the surface of the door frame that faces inside the home or building), and a metal chain 91. One end of the metal chain 91 is secured to the second metal plate 96 and the other end of the metal chain 91 includes a coupling member 93 configured to be removably secured to a groove 94 of the first metal plate 95. The second metal plate 96 is typically mounted to the door frame using 0.5″ manufacturer-provided screws 92.

FIG. 5 illustrates an enhanced view of an example of a sliding deadbolt lock 80 of FIG. 1. FIG. 5 provides the barest of components of the sliding deadbolt lock 80 in order to briefly convey the nature of the device. The sliding deadbolt lock 80 includes a first metal plate 195 mounted to the inner surface 26 of the perimeter door 20, a second metal plate mounted to the door frame 40, and a metal bolt 191. The metal bolt 191 is slidingly attached to the first metal plate 195 and is configured to be inserted into, and out of, a housing structure 194 of the second metal plate 196. The second metal plate 196 is typically mounted on the inner surface 47 of the door frame 40 using 0.5″ manufacturer-provided screws 192.

However, when force is applied to the SPOF 444 of a perimeter door 20 equipped with the door locking system 10 described above, the security of the door can be easily defeated. For example, given the location of the locks and the amount and size of the screws used to mount the striker plates to the door frame 40, a person may be able to use his/her shoulder or a battering ram to apply force directly to the SPOF 444 in order to rip the striker/metal plate from the door frame 40. As defined herein, the term “small amount of force” may correspond to the magnitude of force that may be generated from an adult human when using everyday household tools, such as a hammer, battering ram, crow-bar, pliers, and other tools of simple construction. Typically, this amount of force may be approximately 3 Tons.

One of the most common methods of forced entry is for an intruder to apply force to a perimeter door's SPOF 444 in order to circumvent the locks and gain access to a home or building. Sophisticated criminals can circumvent conventional locks with the use of just a tension wrench and/or a lock pick.

For these reasons, owners/tenants are in need of an enhanced door locking system that provides greater security so that while the owners/tenants are at home they may have peace of mind from potential intruders. In other words, owners/tenants require a perimeter door equipped with an enhanced door locking mechanism configured to withstand an application of a small amount of force to the door's SPOF 444 region, as described above, such that the enhanced door locking system may be easily installed on conventional perimeter doors and quickly and easily locked and unlocked by hand.

### SUMMARY OF THE INVENTION

Embodiments of the present general inventive concept provide a door locking system including two locking assemblies that provide a unified vertical line of security at the closure junction between the door and its associated door frame to enhance security.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a door locking system including a first locking assembly having a first locking actuator mounted on a door and a first catch plate mounted on a door frame, the first locking actuator including a first lever and a first locking plate, the first locking assembly being configured such that, in response to rotating the first lever from an open position to a close position, the first locking plate rotates from an unlocked position to a locked position, respectively, in which the first locking plate is inserted into a groove of the first catch plate when the first locking plate is in its locked position, and a second locking assembly having a second locking actuator mounted on the door and a second catch plate mounted on the door frame, the second locking actuator including a second lever and a second locking plate, the second locking assembly being configured such that, in response to rotating the second lever from an open position to a close position, the second locking plate rotates from an unlocked position to a locked position, respectively, in which the second locking plate is inserted into a groove of the second catch plate when the second locking plate is in its locked position.

The door locking system may be configured such that the first locking assembly is located 12″-16″ from a top edge of the door along a first edge of the door, and the second locking assembly is located 12″-16″ from a base edge of the door along the first edge of the door.

The first and second levers of the first and second locking assemblies may be configured to rotate 90 degrees.

The door locking system may be configured such that in response to rotating the first and second levers 90 degrees, the first and second locking plates rotate 90 degrees, respectively.

The first and second catch plates of the first and second locking assemblies may be mounted to the door frame using 3″ screws.

The door locking system may further comprise at least two hinges secured to a second edge of the door and being configured to rotatingly mount the door on the door frame, wherein the first locking assembly and a first one of the at least two door hinges may be located at substantially a first same distance from the top edge of the door and the second locking assembly and a second one of the at least two door hinges may be located at substantially a second same distance from the base edge of the door.

The groove of the first and second catch plates may include tapered edges that correspond with tapered edges of the first and second locking plates, respectively.

The at least two door hinges each include a protrusion configured to be received by a thimble, the thimble being mounted to an internal metal frame within the door along the second edge of the door.

The first and second locking assemblies may comprise a hard metal, such as aluminum, steel, titanium, or something similar thereto in durability and hardness.

The first and second locking assemblies may comprise a hard metal alloy, such as an aluminum alloy, steel alloy, titanium alloy, or some alloy similar thereto in durability and hardness.

The first and second locking assemblies may be coated with any one of aluminum, iron, and zinc.

The first and second locking actuators may each include a dampener located between the locking plate and a surface thereof.

The foregoing and/or other features and utilities of the present general inventive concept may also be achieved by providing door locking system including a first locking assembly and a second locking assembly, wherein the first and second locking assemblies each include a locking actuator mounted on a door and a catch plate mounted on a door frame, the locking actuator includes a lever and a locking plate, such that, in response to rotating the lever from an open position to a close position, the locking plate rotates from an unlocked position to a locked position, respectively, in which the locking plate is inserted into a groove of the catch plate when the locking plate is in its locked position, and wherein the first locking assembly is located 12″-16″ from a top edge of the door along a first edge of the door and the second locking assembly is located 12″-16″ from a base edge of the door along the first edge of the door.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a front view of a perimeter door equipped with a conventional door locking system;

FIG. 2 illustrates an enhanced view of the conventional door knob lock of FIG. 1;

FIG. 3 illustrates an enhanced view of the conventional deadbolt lock of FIG. 1;

FIG. 4 illustrates an enhanced view of the conventional lock-and-chain lock of FIG. 1;

FIG. 5 illustrates an enhanced view of the conventional sliding deadbolt lock of FIG. 1;

FIGS. 6A-6C illustrate a top-side view, a bottom-side view, and a perspective view, respectively, of a locking actuator device according to embodiments of the present general inventive concept;

FIG. 7 illustrates a perspective view of a locking plate according to embodiments of the present general inventive concept;

FIG. 8 illustrates a perspective view of a catch plate according to embodiments of the present general inventive concept;

FIG. 9A illustrates a perspective view of a door hinge according to embodiments of the present general inventive concept;

FIG. 9B illustrates a perspective view of a thimble used with the door hinge of FIG. 9A in accordance with embodiments of the present general inventive concept; and

FIGS. 10A-10B illustrate a front view and a side view, respectively, of a door locking system according to embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

It will be understood that, although the terms first, second, etc. may be used herein to describe various elements, these elements should not be limited by these terms. These terms are only used to distinguish one element from another. The terminology used herein describes exemplary embodiments only and is not intended to be limiting of the present general inventive concept. As used herein, the singular forms “a,” “an” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will also be understood that when an element is referred to as being “on” or “onto” another element, it may lie directly on the other element or intervening elements or layers may also be present. It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless otherwise defined, all terms used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

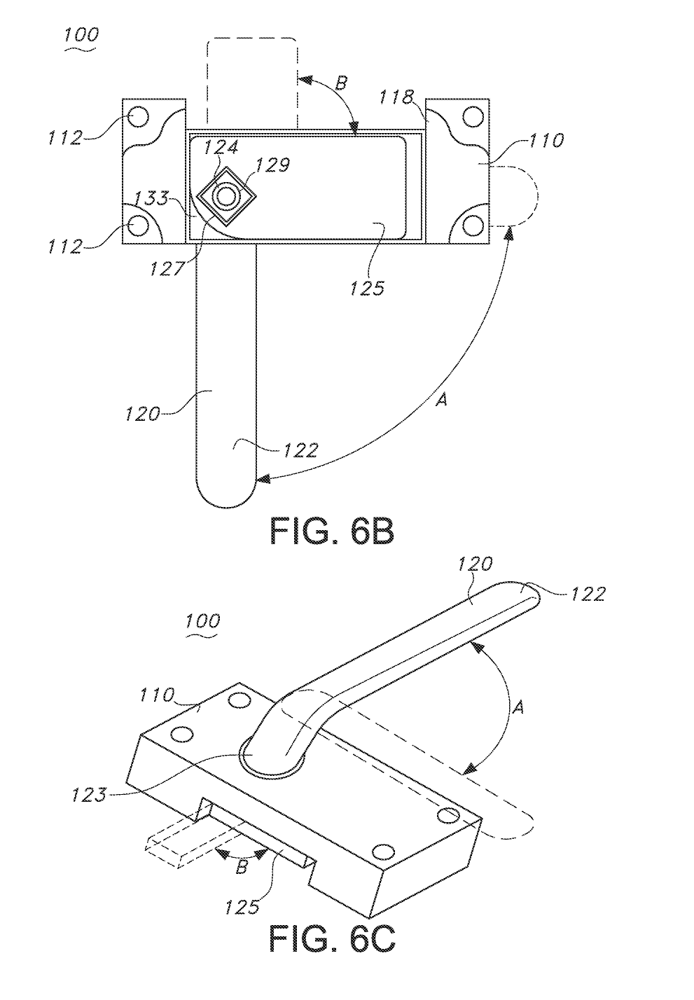

FIGS. 6A-6C illustrate a locking actuator device 100 according to embodiments of the present general inventive concept. The locking actuator device 100 may be comprised of a hard metal, such as aluminum, steel, titanium, or something similar thereto in durability and hardness. Alternatively, the locking actuator device 100 may be comprised of a metal alloy, such as an aluminum alloy, steel alloy, titanium alloy, or some alloy similar thereto in durability and hardness. In a further example, each component of the locking device may be one of a hard metal and a metal alloy. Further, the locking actuator device 100 may be coated with any one of aluminum, iron, and zinc, for aesthetic purposes, so long as the coating does not alter the mechanical aspects of the locking actuator device 100.

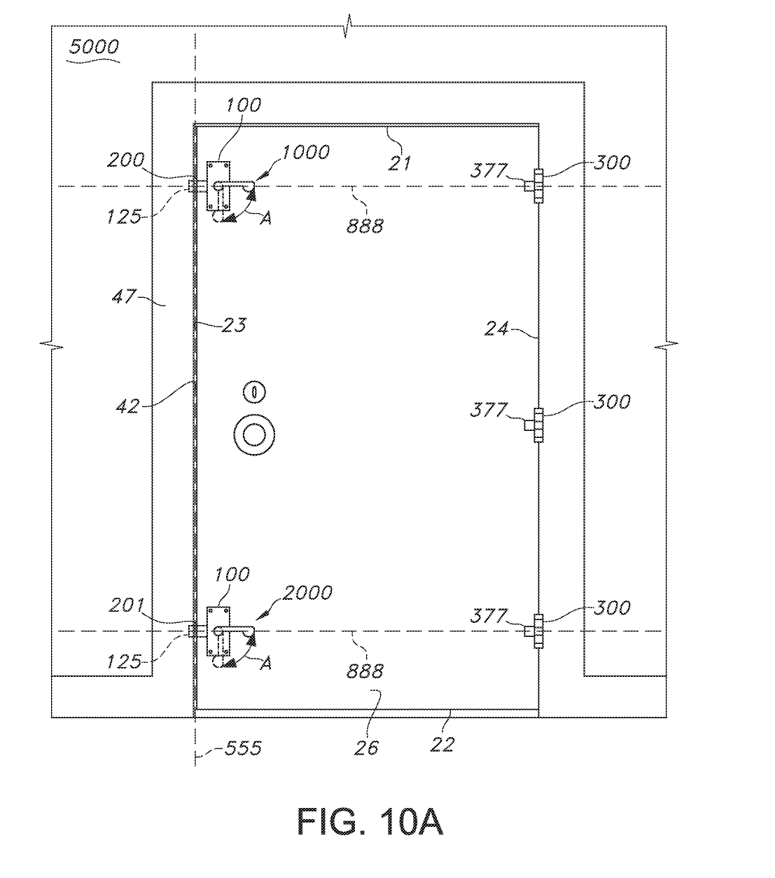

Referring to FIG. 6A, the locking actuator device 100 may include a housing 110 and a locking lever 120. The housing 110 may be substantially rectangular in shape and may include at least four (4) mounting holes 112 and a lever hole 113. However, the present general inventive concept is not limited thereto. For example, the housing 110 may include seven (7) mounting holes, as illustrated in by the three additional mounting holes illustrated in dotted-lines. The mounting holes 112 may be used to mount the housing 110 on a door 20, as discussed below in detail with reference to FIG. 10. The lever hole 113 is configured to receive the locking lever 120 so that the locking lever 120 may be rotatingly coupled to the housing 110.

The housing 110 may have a box-type rectangular shape with four long-edged surfaces extending approximately 3″ in length (x-direction) and 1.25″ in width (y-direction) that are held together by two opposing short-edged surfaces extending approximately 1.25″ in height (z-direction) and 1.25″ in width. The locking lever 120 may include a handle portion 122 that extends approximately 3″ in length in a first direction and an actuator portion 123 that extends approximately 1″ in length in a second direction substantially perpendicular to the first direction. However, the present general inventive concept is not limited to the dimensions discussed above. For example, the housing 110 and locking lever 120 may have larger or smaller dimensions substantially relative to the dimensions discussed above to favor personal aesthetic and/or ergonomic preference.

Referring to FIG. 6B and 6C, the locking lever 120 may comprise the handle portion 122 and the actuator portion 123. The actuator portion 123 may be hollow and extend the lever hole 113 of the housing 110. The handle portion 122 may be ergonomically designed for easy hand-held manipulation. The actuator portion 123 is designed such that it includes a bulbous metal end 124 at its tip, as illustrated in FIG. 6B. The actuator portion 123 is configured to extend through the lever hole 113 of the housing 110 such that the bulbous metal end 124 has an edge 129 that secures a locking plate 125 to the housing 110.

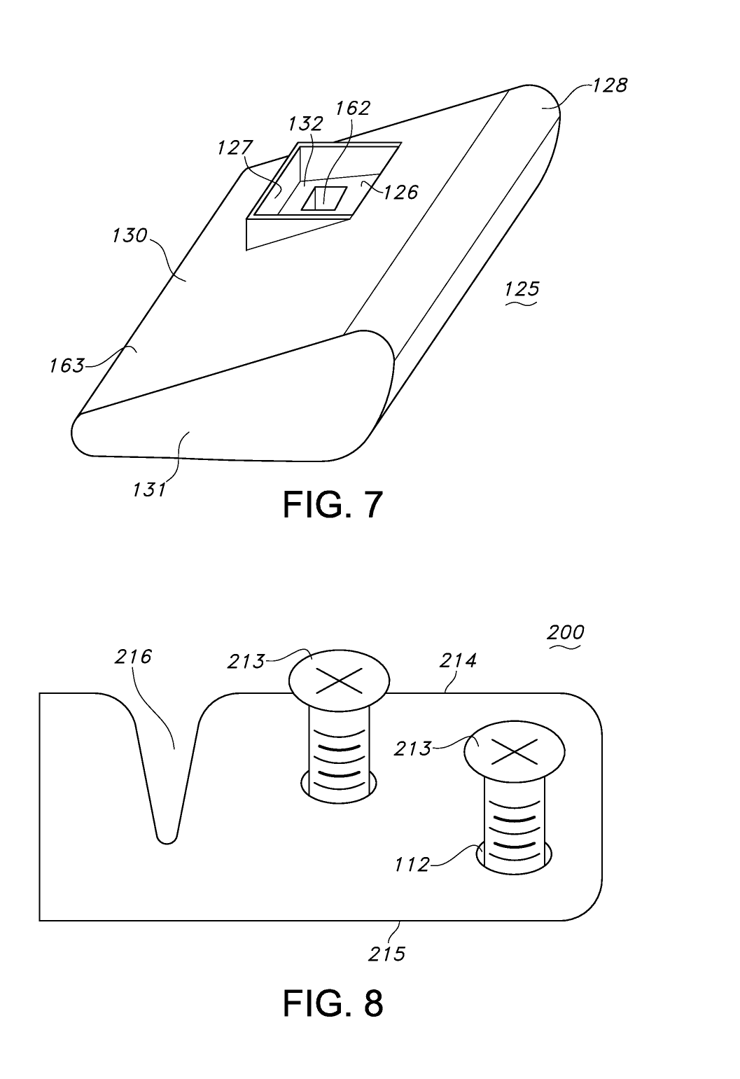

FIG. 7 illustrates a perspective view of the locking plate 125. Referring to FIG. 7, the locking plate 125 is substantially wedge-shaped with dimensions 1.5″×1″ and has a thickness between 0.1″-0.2″. Further, the locking plate 125 tapers from one long-edge to the other long-edge. More specifically, the locking plate 125 has a thick edge 128 and a thin edge 130 that together form a locking edge 131. The locking plate 125 includes a hole 162 and one side surface 163 of the locking plate 125 includes a cavity 126 that surrounds the hole 162. The cavity 126 may be substantially square in shape and may be defined by sidewall surfaces 127. The sidewall surfaces 127 may extend above the one side surface 163 of the locking plate 125 at the thin edge 130 portion of the locking plate 125 to accommodate the bulbous metal end 124 of the actuator portion 123. One corner of the locking plate 125 may be substantially rounded to accommodate for the rotation of the locking plate 125, as illustrated in FIG. 6B.

The actuator portion 123 of the locking lever 120 extends through the lever hole 113 of the housing 110 and through the hole 162 of the locking plate 125. A washer 119 may be provided in the lever hole 113 between the housing 110 and the actuator portion 123 to reduce friction and wearing. The bulbous metal end 124 contacts a bottom surface 132 of the cavity 126 and the sidewall surfaces 127 of the cavity 126 to rotatably fasten the locking plate 125 to the housing 110. The bulbous metal end 124 may completely or partially fill the cavity 126 of the locking plate 125.

Referring to FIG. 68, the housing 110 may include a recess 115 along one long-edged surface to accommodate rotation of the locking plate 125. The recess 115 of the housing 110 may be designed so that the locking lever 120 has a 90° angle of rotation. However, the present general inventive concept is not limited thereto. For example, the locking lever may be configured to rotate at any angle between 60° and 180° without deviating from the scope and spirit of the present general inventive concept.

The bulbous metal end 124 and the cavity 126 are shaped so that, upon rotation of the locking lever 120 from its open position to its close position, i.e., rotating 90° in the direction of arrow A, the bulbous metal end 124 contacts the sidewall surfaces 127 of the cavity 126 which causes the locking plate 125 to rotate 90° in the direction of arrow B. The locking lever 120 may be configured to rotate 90° from a first position, e.g., open position illustrated in solid lines, to a second position, e.g., locking position illustrated in dotted-lines, as illustrated in FIG. 6B. In other words, the rotation of the locking lever 120 from its open position to its close position causes the locking plate 125 to rotate from its first position, e.g., unlocking position, to its second position, e.g., locking position, respectively.

The locking actuator device 100 may include padding or a dampener 133 disposed between the locking plate 125 and a surface 118 of the housing 110 to reduce friction and provide a smooth rotation of the locking lever 120 as the locking plate 125 rotates from its first position, e.g., open position, to its second position, e.g., locking position. The dampener 133 may be comprised of a metal, a metal alloy, a plastic, a resin, or something similar thereto.

FIG. 8 illustrates a perspective view of a catch plate 200 according to embodiments of the present general inventive concept. The catch plate 200 may be comprised of a hard metal, such as aluminum, steel, titanium, or something similar thereto in durability and hardness. Alternatively, the catch plate 200 may be comprised of a metal alloy, such as aluminum alloy, steel alloy, titanium alloy, or some alloy similar thereto in durability and hardness. In addition, the catch plate 200 may be coated with any one of aluminum, iron, and zinc, for aesthetic purposes, so long as the coating does not alter the mechanical and durability aspects of the catch plate 200.

Referring to FIG. 8, the catch plate 200 may be substantially rectangular in shape with dimensions 0.375″×1.75″ and having a thickness between 0.1″-0.2″. However, the present general inventive concept is not limited thereto. For example, the catch plate 200 may have a circular shape, an oval shape, or a shape similar thereto. The catch plate 200 may include two (2) mounting holes 212 disposed on one side of a groove 216. However, the present general inventive concept is not limited thereto. For example, the catch plate 200 may include three (3) mounting holes, as indicated by the additional mounting hole illustrated in dotted-lines. The mounting holes 212 may be used to mount the catch plate 200 on the door frame 40, as discussed below in detail with reference to FIG. 10.

The groove 216 of the catch plate 200 may extend from a first long-edge 214 of the catch plate 200 toward a second long-edge 215 of the catch plate 200 that is opposite to the first long-edge 214, as illustrated in FIG. 8. The groove 216 may extend partially from the first long-edge 214 to the second long-edge 215. More specifically, the groove 216 may extend between ¼-½ the distance between the first and second long-edges 214, 215 of the catch plate 200, i.e., between ¼ and ½ of 0.375″. The groove 216 may be tapered and correspond to the tapered thickness of the locking edge 131 of the locking plate 125.

More specifically, the tapered shape of the groove 216 of the catch plate 200 is substantially similar to the tapered shape of the locking edge 195 of the locking plate 125 such that the locking plate 125 snugly fits into the groove 216, as discussed in detail below with reference to FIG. 10. The groove 216 of the catch plate 200 may be coated with a plastic-type of material to protect the groove 16 of the catch plate 200 and to protect the locking plate 125 of the locking actuator device 100. For example, the groove 216 may be coated with Teflon® or a material similar thereto.

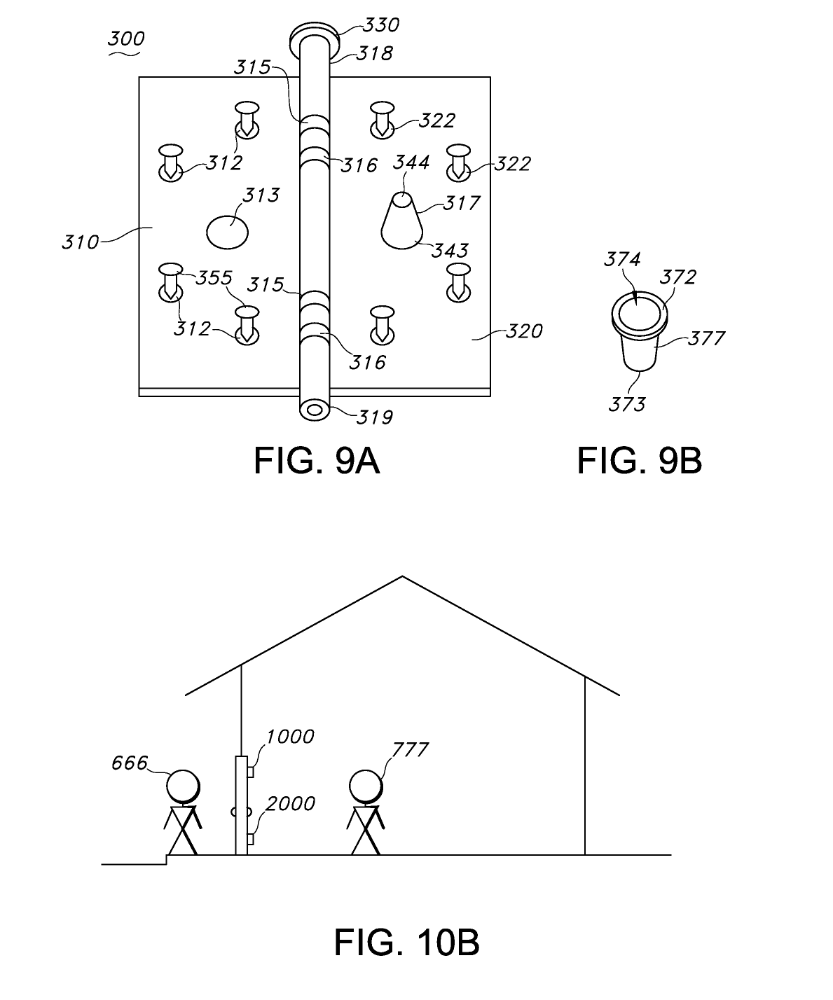

FIG. 9A illustrates a perspective view of a door hinge 300 according to embodiments of the present general inventive concept. The door hinge 300 may be comprised of a hard metal, such as aluminum, steel, titanium, or something similar thereto in durability and hardness. Alternatively, the door hinge 300 may be comprised of a metal alloy, such as aluminum alloy, steel alloy, titanium alloy, or some alloy similar thereto in durability and hardness. In addition, the door hinge 300 may be coated with any one of aluminum, iron, and zinc, for aesthetic purposes, so long as the coating does not alter the mechanical and durability aspects of the door hinge 300.

Referring to FIGS. 9A and 9B, the door hinge 300 includes a first metal plate 310, a second metal plate 320, a thimble 377, and a metal pin 330. The first metal plate 310 may be rectangular in shape and include at least four (4) mounting holes 312 and a protrusion hole 313. The protrusion hole 313 may be circular in shape, but the present general inventive concept is not limited thereto. For example, the protrusion hole 313 may have an oval shape, a square shape, a star shape, or any shape so long as it does not deviate from the scope and spirit of the present general inventive concept. The first metal plate 310 may include coupling members 315 along a coupling edge 318.

The second metal plate 320 may be rectangular in shape and include at least four (4) mounting holes 322 and a protrusion 317. The mounting holes 322 of the second metal plate 320 may be larger in cross-section than the mounting holes 312 of the first mounting plate 310. The protrusion 317 may be cylindrical in shape having a height between 1″-3″ and is configured to be inserted into the protrusion hole 313, as discussed in detail below with reference to FIG. 10. The protrusion 317 may be tapered such that a base 343 of the protrusion 317 is thicker than a tip 344 of the protrusion.

The present general inventive concept is not limited to a cylindrical protrusion. For example, the protrusion 317 may have a three-dimensional (3D) oval shape, a cubic shape, a 3D star shape, or any shape so long as it conforms to the shape of the protrusion hole 313 of the first metal plate 310 and does not deviate from the scope and spirit of the present general inventive concept. The second metal plate 320 may include coupling members 316 along a coupling edge 319.

Referring to FIG. 9B, the thimble 377 may be cylindrical in shape having a height between 1″-3″ and is configured to be inserted into the protrusion hole 313, as discussed in detail below with reference to FIG. 10. The thimble 377 may be tapered such that a base 373 of the thimble has a smaller cross-section than an inserting hole 374 of the thimble 377. The thimble may have a thick metal ring 372 around the inserting hole 374.

The present general inventive concept is not limited to a cylindrical thimble 377. For example, the thimble 377 may have a three-dimensional (3D) oval shape, a cubic shape, a 3D star shape, or any shape so long as it conforms to the shape of the protrusion 317 of the second metal plate 320 and does not deviate from the scope and spirit of the present general inventive concept

Referring to FIG. 9A, the metal pin 330 may be slid ugly coupled within the coupling members 315, 316 of the first and second metal plates 310, 320 to provide the door hinge 300 in a state in which the first metal plate 310 and the second metal plate 320 may be mounted to a door 20 and door frame 40, respectively, as discussed in detail below with references to FIG. 10.

FIGS. 10A-10B illustrate a front view and a side view, respectively, of a door locking system 5000 according to embodiments of the present general inventive concept. The door locking system 5000 may include a first locking assembly 1000 and a second locking assembly 2000. Each of the first and second locking assemblies 1000, 2000 may include the locking device actuator 100 and a corresponding catch plate 200 discussed above.

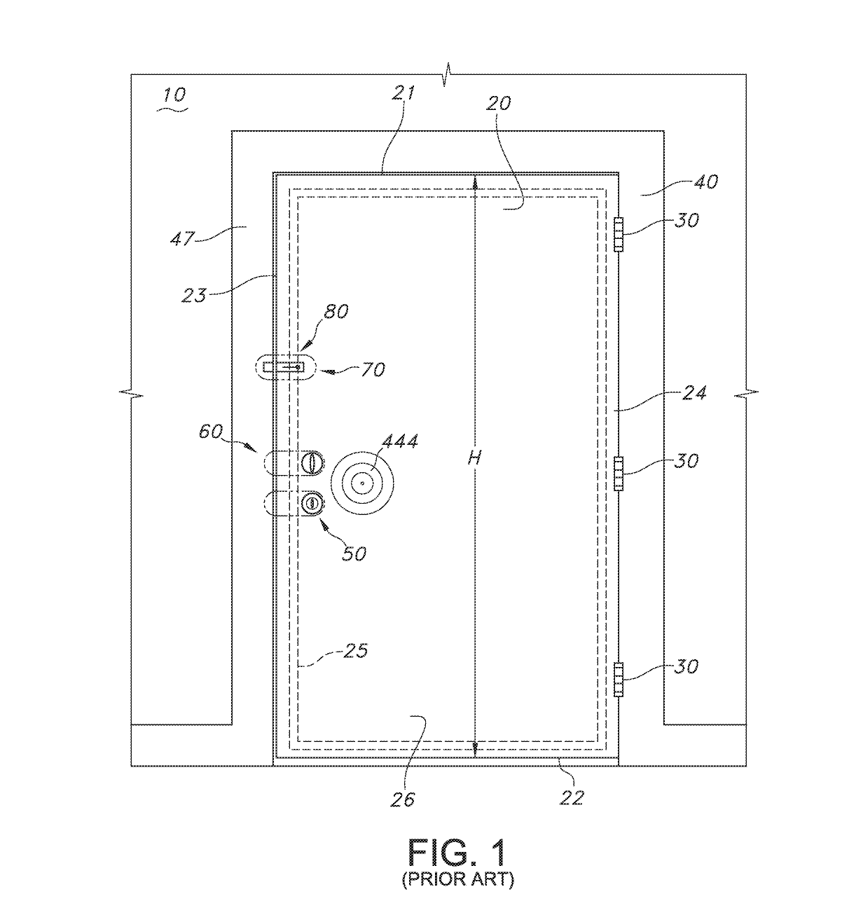

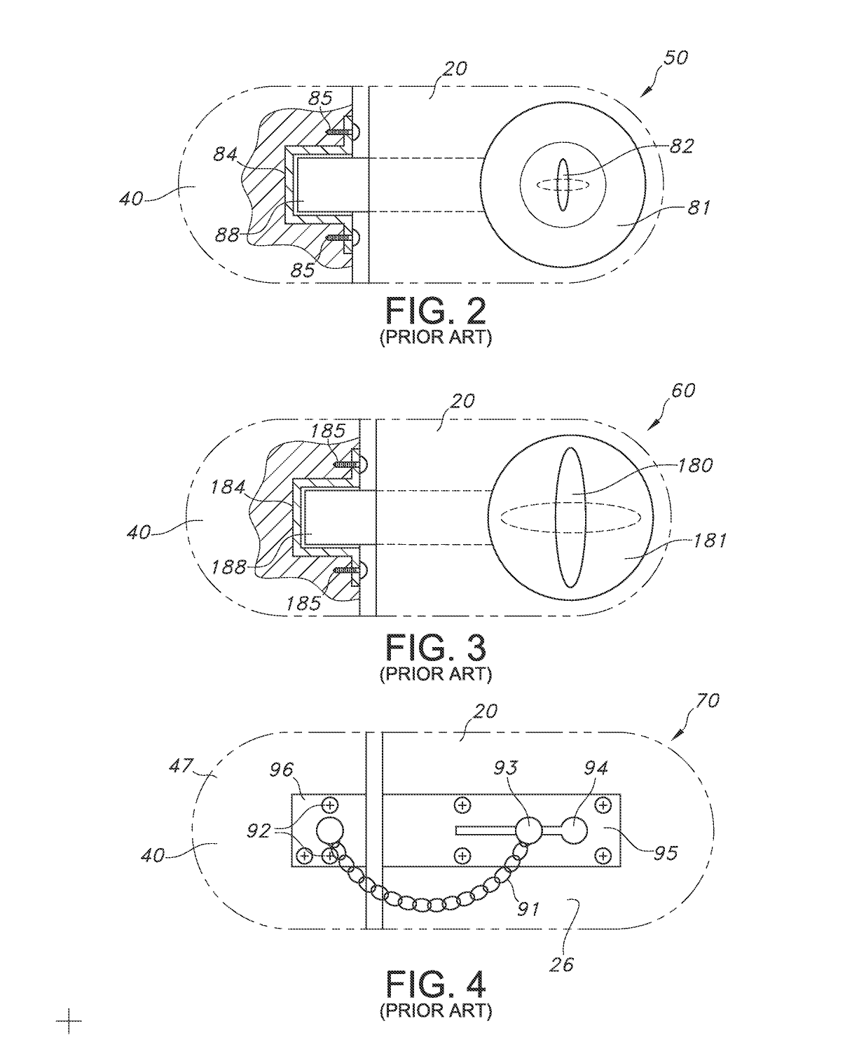

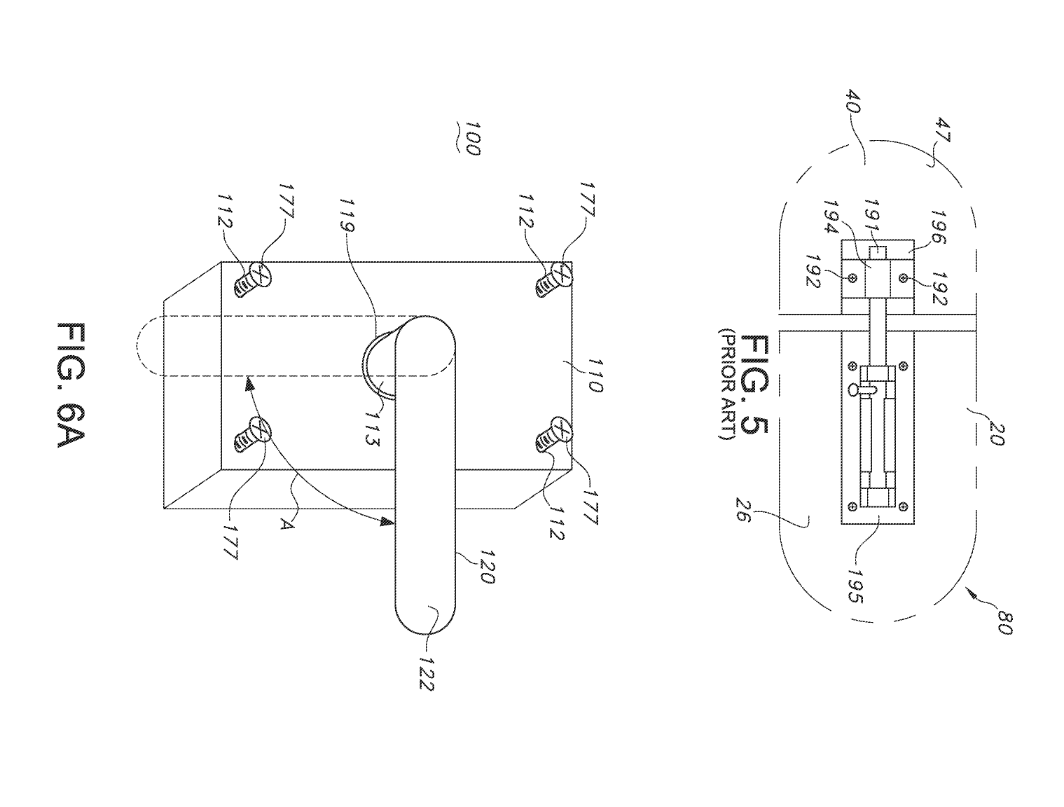

A perimeter door 20 of a home or building may include an internal metal frame 25 along its perimeter and is secured to a door frame 40 using three (3) door hinges 30, as illustrated in FIG. 1. Conventional door hinges 30, as illustrated in FIG. 1, typically do not include the protrusion 317 and corresponding protrusion hole 313 of the door hinge 300 illustrated in FIG. 9. However, the door locking system 5000 of the present general inventive concept may include the door hinges 300 of FIG. 9 to enhance security.

Referring to FIGS. 9A, 9B, and 10A, the door hinges 300 are secured to the door 20 using at least four (4) 1.25″ screws 355 that may be screwed through mounting holes 312 of the first metal plate 310. One of the three door hinges 300 may be located near the top edge 21 of the door 20, e.g. between 12″-16″ from the top edge 21 of the door 20 along the second edge 24 of the door 20. One of the three door hinges 300 may be located near the base edge 22 of the door 20, e.g., between 12″-16″ from the base edge 22 of the door 20, along the second edge 24 of the door 20. The door hinges 300 may be secured to the door frame 40 using at least four (4) 3″ screws 350 that may be screwed through mounting holes 322 of the second metal plate 320. The door hinges 300 may be the hinges of FIGS. 9A and 9B.

The thimble 377 of the door hinge 300 may be inserted through the protrusion hole 313 and secured within the internal metal frame 25 of the door 20. Here, the door 20 may include a recess or hole, having similar dimensions as the thimble 377, within the internal metal frame 25 to accommodate the thimble 377. Upon assembly of the door hinges 300, the protrusion 317 is configured to be inserted through the protrusion hole 313 and fit snugly into the thimble 377 when the door is in is closed position.

Referring to FIG. 10A, the door locking system 5000 includes at least two (2) locking assemblies 1000, 2000 in which the first locking assembly 1000 includes a first locking actuator device 100 and a corresponding first catch plate 200 and the second locking assembly 2000 includes a second locking actuator device 101 and a corresponding second catch plate 201. The first and second locking actuator devices 100, 101 may be the locking actuator device 100 of FIG. 6. The first and second catch plates 200, 201 may be the catch plate 200 of FIG. 8.

Referring to FIGS. 1, 6A and 10A, the locking actuator device 100 of the first locking assembly 1000 may be mounted to the internal metal frame 25 of the door 20 using at least four (4) 1.25″ screws 177. However, the present general inventive concept is not limited thereto. For example, the locking actuator device 100 may be mounted to the internal metal frame 25 of the door 20 using seven (7) 1.25″ screws 177.

The first locking assembly 1000 may be configured such that the first locking actuator device 100 is located near the top edge 21 of the door 20, e.g., between 12″-16″ from the top edge 21 of the door 20, along the first edge 23 of the door 20, and the first catch plate 200 is located adjacent the first locking actuator device 100 so that when the locking lever 120 is in its closed position (i.e., extending in a direction parallel to the first edge 23 of the door 20, as illustrated in dotted-lined of FIG. 10A), the locking plate 125 may be inserted into the groove 216 of the first catch plate 200. Similarly, the second locking assembly 2000 may be configured such that the second locking actuator device 101 is located near the base edge 22 of the door 20, e.g., between 12″-16″ from the base edge 22 of the door 20, along the first edge 23 of the door 20, and the second catch plate 201 is located adjacent the second locking actuator device 101 so that when the locking lever 120 is in its closed position the locking plate 125 is inserted into the groove 216 of the second catch plate 201.

Accordingly, the first locking assembly 1000 and the uppermost hinge 300 may be disposed at substantially the same distance from the top edge 21 of the door 20 such that the first locking assembly 1000 is located along the first edge 23 of the door 20 and the uppermost hinge 300 is located along the second edge 24 of the door 20. Similarly, the second locking assembly 2000 and the lowermost hinge 300 may be disposed at substantially the same distance from the base edge 22 of the door 20 such that the second locking assembly 2000 is located along the first edge 23 of the door 20 and the lowermost hinge 300 is located along the second edge 24 of the door 20.

The catch plate 200 of the first locking assembly 1000 may be mounted on an inside surface 42 of the door frame 40 (i.e., surface of the door frame that faces the door 20 when the door is in its closed position) using at least two (2) 3″ screws 213. However, the present general inventive concept is not limited thereto. For example, the catch plate 200 may be mounted on the inside surface 42 of the door frame 40 using three (3) 3″ screws 211.

The second locking actuator device 101 and the second catch plate 201 of the second locking assembly 2000 may be mounted to the door 20 and door frame 40, respectively, in a similar manner to that described above with respect to the first locking assembly 1000.

Accordingly, the catch plates 200, 201, when coupled with the locking plates 125 of the first and second locking actuator devices 100, 101, respectively, locks the door 20 in its closed position while removing the single point of failure 444. Due to the location of the first and second locking assemblies 1000, 2000 with respect to the door's first edge 22 and with respect to the door hinges 300, and because the screws used to secure the catch plates 200, 201 to the door frame 40 are up to six (6) times larger than conventionally used screws, the door locking system 5000 provides a unified vertical line of security 555 and two horizontal lines of security 888.

More specifically, as discussed above, conventional locking mechanisms typically utilize two (2) 0.5″ screws to secure a corresponding striker metal plate to a door frame and each of the locking mechanisms are located at a middle region of a door. The present general inventive concept, on the other hand, provides the door locking system 5000 that strategically locates first and second locking assemblies 1000, 2000 at positions that are 12″-16″ from the top and bottom edges, respectively, of the door 20. Further, the catch plates 200 are properly secured to the inside surface 42 of the door frame 40 using 3.0″ screws to prevent the catch plate from being ripped from the door frame 40 when force is applied thereto.

Mounting the first and second locking assemblies 1000, 2000 along the door's 20 first edge 23 at positions 12″-16″ from the top edge 21 and base edge 22, as illustrated in FIG. 10A, the door locking system 5000 provides both a unified vertical line of security 555 along the closure junction between the door 20 and door frame 40, as indicated by the dotted line of FIG. 10A, and provides two unified horizontal lines of security 888 along lines connecting the first and second locking assemblies with its corresponding door hinge 300, as indicated by the dotted lines of FIG. 10A.

Embodiments of the present general inventive concept remove the single point of failure 444, as illustrated in FIG. 1, from conventional door locking systems. That is, applying force to the door 20 at a position that is close to any lock site of the door locking system 5000 of the present general inventive concept would be insufficient to circumvent the locks and/or tear the catch plate 200, 201 from the door frame 40 to open the door 20 and gain entry.

In contrast with previous locking systems, the closure junction between the door 20 and the door frame 40 does not include the single point of failure 444 such that a potential intruder may apply force thereto in order to circumvent the locking mechanism and open the door. Rather, the first and second locking assemblies 1000, 2000 of the door locking system 5000 work in concert to provide the unified vertical line of security 555 along the closure junction between the door 20 and the door frame 40 and the unified horizontal lines of security 888 along lines connecting the first and second locking assemblies with its corresponding door hinge 300. The door locking system 5000 may be used together with conventional door locking systems or the door locking system 5000 may replace conventional door locking systems.

Referring to FIG. 10B, the door locking system 5000 may be manually operated by owner/tenant 777 while the owner/tenant 777 is inside their home or building to enhance security and have peace of mind from a potential intruder(s) 666. In other words, the door locking system 5000 of the present general inventive concept provides a unified line of security 555 along the closure junction between the door 20 and the door frame 40 when the locking actuator assemblies 1000, 2000 are in their locked state.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A door looking system, comprising:
a first locking assembly having a first locking actuator mounted on a door and a first catch plate mounted on a door frame, the first locking actuator including a first lever and a first locking plate, the first locking assembly being configured such that, in response to rotating the first lever from an open position to a close position, the first locking plate rotates from an unlocked position to a locked position, respectively, in which the first locking plate is inserted into a groove of the first catch plate when the first locking plate is in its locked position; and
a second locking assembly having a second locking actuator mounted on the door and a second catch plate mounted on the door frame, the second locking actuator including a second lever and a second locking plate, the second locking assembly being configured such that, in response to rotating the second lever from an open position to a close position, the second locking plate rotates from an unlocked position to a locked position, respectively, in which the second locking plate is inserted into a groove of the second catch plate when the second locking plate is in its locked position.

2. The door locking system of claim 1, wherein the first locking assembly is located 12″-16″ from a top edge of the door along a first edge of the door and the second locking assembly is located 12″-16″ from a base edge of the door along the first edge of the door.

3. The door locking system of claim 1, wherein the first and second levers are configured to rotate 90 degrees.

4. The door locking system of claim 3, wherein, in response to rotating first and second levers 90 degrees, the first and second locking plates rotate 90 degrees, respectively.

5. The door locking system of claim 1, wherein the first and second catch plates are mounted to the door frame using 3″ screws.

6. The door locking system of claim 2, further comprising:
at least two door hinges secured to a second edge of the door and being configured to rotatingly mount the door on the door frame,
wherein the first locking assembly and a first one of the at least two door hinges are located at substantially a first same distance from the top edge of the door, and the second locking assembly and a second one of the at least two door hinges are located at substantially a second same distance from the base edge of the door.

7. The door locking system of claim 1, wherein the groove of the first and second catch plates includes tapered edges that correspond with tapered edges of the first and second locking plates, respectively.

8. The door locking system of claim 6, wherein the at least two door hinges each include a protrusion configured to be received by a thimble, the thimble being mounted to an internal metal frame within the door along the second edge of the door.

9. The door locking system of claim 1, wherein the first and second locking assemblies comprise a hard metal, such as aluminum, steel, titanium, or something similar thereto in durability and hardness.

10. The door locking system of claim 1, wherein the first and second locking assemblies comprise a hard metal alloy, such as an aluminum alloy, steel alloy, titanium alloy, or some alloy similar thereto in durability and hardness.

11. The door locking system of claim 10, wherein the first and second locking assemblies are coated with any one of aluminum, iron, and zinc.

12. The door locking system of claim 1, wherein the first and second locking actuators each include a dampener located between the locking plate and a surface thereof.

13. A door locking system, comprising:
a first locking assembly; and
a second locking assembly,
wherein the first and second locking assemblies each include a locking actuator mounted on a door and a catch plate mounted on a door frame, the locking actuator includes a lever and a locking plate, such that, in response to rotating the lever from an open position to a close position, the locking plate rotates from an unlocked position to a locked position, respectively, in which the locking plate is inserted into a groove of the catch plate when the locking plate is in its locked position, and
wherein the first locking assembly is located 12″-16″ from a top edge of the door along a first edge of the door and the second locking assembly is located 12″-16″ from a base edge of the door along the first edge of the door.
